(19) United States
(12) Patent Application Publication
(10) Pub. No.: US 2021/0279637 A1
(43) Pub. Date: Sep. 9, 2021

(54) LABEL COLLECTION APPARATUS, LABEL COLLECTION METHOD, AND LABEL COLLECTION PROGRAM

(71) Applicant: Kyushu Institute of Technology, Fukuoka (JP)

(72) Inventor: Sozo Inoue, Fukuoka (JP)

(21) Appl. No.: 16/967,639

(22) PCT Filed: Feb. 4, 2019
(86) PCT No.: PCT/JP2019/003818

§ 371 Date: Aug. 5, 2020

(30) Foreign Application Priority Data
Feb. 27, 2018 (JP) 2018-033655

(51) Int. Cl. G06N 20/00

(52) U.S. Cl. CPC G06N 20/00

(57) ABSTRACT

A label collection apparatus includes an acquirer configured to acquire a teacher label of teacher data used for machine learning, a learning processor configured to execute machine learning of a model on the basis of the teacher data including the acquired teacher label, an accuracy detector configured to detect an accuracy of the model, and a presentation processor configured to present the accuracy, in which the acquirer is configured to acquire updated teacher data.

### TECHNICAL FIELD

The present invention relates to a label collection apparatus, a label collection method, and a label collection program.

Priority is claimed on Japanese Patent Application No. 2018-033655, filed Feb. 27, 2018, the content of which is incorporated herein by reference.

### Background Art

Machine learning with a teacher that is a field of machine learning may be executed to recognize a behavior of a person on the basis of sensor data and the like (refer to Non-Patent Document 1). Phases of the machine learning with a teacher include a learning (training) phase and a determination (evaluation) phase.

### Citation List

### Non-Patent Literature

### Non-Patent Document 1

Nattaya Mairittha (Fah), Sozo Inoue, “Exploring the Challenges of Gamification in Mobile Activity Recognition”, SOFT Kyushu Chapter Academic Lecture, pp.47-50, 2017-12-02, Kagoshima.

### SUMNARY OF INVENTION

### Technical Problem

In the learning phase, teacher data is created by giving a teacher label to a sample that is sensor data or the like (annotations). An operation of creating teacher data requires a lot of time and effort, and thus this imposes a large burden on a creator. For this reason, the creator may give a teacher label which has little relation to a sample to the sample due to human errors, concentration, incentives, or the like. In this case, the accuracy of machine learning that recognizes the behavior of a person on the basis of the sample may decline.

In order to prevent the accuracy of machine learning from declining, it is necessary to collect a teacher label of teacher data that improves the accuracy of machine learning. However, a conventional label collection apparatus may not be able to collect the teacher label of teacher data that improves the accuracy of machine learning.

In view of the above circumstances, an object of the present invention is to provide a label collection apparatus, a label collection method, and a label collection program which can collect a teacher label of teacher data that improves the accuracy of machine learning.

### Solution to Problem

According to one aspect of the present invention, a label collection apparatus includes an acquirer configured to acquire a teacher label of teacher data used for machine learning, a learning processor configured to execute machine learning of a model on the basis of the teacher data including the acquired teacher label, an accuracy detector configured to detect an accuracy of the model, and a presentation processor configured to present the accuracy, in which the acquirer is configured to acquire updated teacher data.

According to one aspect of the present invention, a label collection apparatus includes an acquirer configured to acquire a first teacher label of first teacher data used for machine learning, a learning processor configured to execute machine learning of a first model on the basis of the first teacher data including an acquired first teacher label and a sample, an accuracy detector configured to detect an accuracy of the first model, a presentation processor configured to present the accuracy, and a warning processor configured to output a warning when a similarity degree between the first teacher data and second teacher data including a second teacher label which is a correct as a behavior label for the sample is equal to or less than a predetermined similarity threshold value, in which the acquirer acquires updated first teacher data.

In the label collection apparatus described above according to one aspect of the present invention, the learning processor is configured to execute machine learning of a second model on the basis of third teacher data including a third teacher label which is not correct as a behavior label for the sample and the second teacher data including the second teacher label, and the warning processor is configured to output a warning when an accuracy of the second model for the first teacher data is equal to or less than a predetermined accuracy threshold value.

In the label collection apparatus described above according to one aspect of the present invention, the sample is sensor data, and the first teacher label is a label representing a behavior of a person.

According to another aspect of the present invention, a label collection method includes a step of acquiring a first teacher label of first teacher data used for machine learning, a step of executing machine learning of a first model on the basis of the first teacher data including the acquired first teacher label and a sample, a step of detecting an accuracy of the first model, a step of presenting the accuracy, a step of outputting a warning when a similarity degree between the first teacher data and second teacher data including a second teacher label which does not have little relation to the sample is equal to or less than a predetermined similarity threshold value, and a step of acquiring updated first teacher data.

According to still another aspect of the present invention, a label collection program causes a computer to execute a procedure for acquiring a first teacher label of first teacher data used for machine learning, a procedure for executing machine learning of a first model on the basis of the first teacher data including the acquired first teacher label and a sample, a procedure for detecting an accuracy of the first model, a procedure for presenting the accuracy, a procedure for outputting a warning when the similarity degree between the first teacher data and second teacher data including a second teacher label which does not have little relation to the sample is equal to or less than a predetermined similarity threshold value, and a procedure for acquiring updated first teacher data.

### Advantageous Effects of Invention

According to the present invention, it is possible to collect a teacher label of teacher data that improves the accuracy of machine learning.

### BRIEF DESCRIPTION OF DRAWINGS

FIG. 1 is a diagram which shows an example of a configuration of a label collection apparatus in a first embodiment.

FIG. 2 is a flowchart which shows examples of creation processing of teacher data by a creator and an operation of the label collection apparatus in the first embodiment.

FIG. 3 is a diagram which shows an example of a configuration of a label collection apparatus in a second embodiment.

FIG. 4 is a flowchart which shows an example of an operation of the label collection apparatus in the second embodiment.

FIG. 5 is a diagram which shows an example of a configuration of a label collection apparatus in a third embodiment.

FIG. 6 is a flowchart which shows a learning example of a determination model in the third embodiment.

FIG. 7 is a flowchart which shows a determination example of an accuracy of the determination model in the third embodiment.

### DESCRIPTION OF EMBODIMENTS

Embodiments of the present invention will be described in detail with reference to the drawings.

### First Embodiment

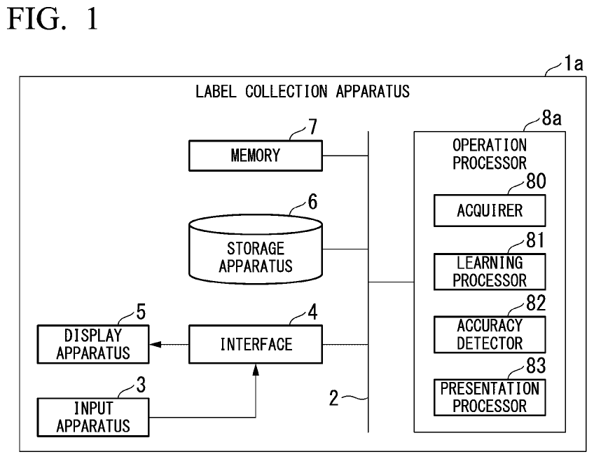

FIG. 1 is a diagram which shows an example of a configuration of a label collection apparatus 1a. The label collection apparatus 1a is an information processing apparatus that collects a teacher label of teacher data used for machine learning, and is, for example, a personal computer, a smartphone terminal, a tablet terminal, or the like. The teacher label is a behavior label for the sample, and is, for example, a label representing a behavior of a person.

The label collection apparatus 1a stores a set X of a sample x as input data. In the following description, the number of samples (the number of elements) of the set is one or more. The sample x is sensor data, and includes, for example, image data, voice data, acceleration data, temperature data, and illuminance data. The image data is, for example, data of a moving image or a still image in which a nurse is photographed by a camera attached to a hospital room. The data of an image may contain a recognition result of characters contained in the image. The voice image is, for example, data of voice received by a microphone carried by a nurse on duty. The acceleration data is, for example, data of acceleration detected by an acceleration sensor carried by a nurse on duty.

One or more creators create teacher data dᵢ (=(sample xᵢ, teacher label yᵢ)) used for machine learning by giving a teacher label (a classification class) to the sample xᵢ that constitutes a set X of a sample. A subscript i of dᵢ represents an index of a sample included in the teacher data.

The creator confirms a sample x presented from the label collection apparatus 1a and determines a teacher label y to be given to the sample x. For example, the creator can give a teacher label such as “dog” or “cat” to still image data that is non-series data. For example, the creator can give a teacher label “medication” to a sample x that is still image data in which a figure of a nurse medicating a patient is photographed. The creator can give a teacher label in a set form such as “a start time, an end time, or a classification class” to voice data that is series data. The creator records a teacher label given to a sample x in the label collection apparatus 1a by operating the label collection apparatus 1a.

In the following description, a sample x is non-series data as an example. A set Y of teacher labels is expressed in a form of {y₁, . . . , yₙ} as an example.

The label collection apparatus 1a includes a bus 2, an input apparatus 3, an interface 4, a display apparatus 5, a storage apparatus 6, a memory 7, and an operation processor 8a.

The bus 2 transfers data between respective functional parts of the label collection apparatus 1a.

The input apparatus 3 is configured using existing input apparatuses such as a keyboard, pointing apparatuses (a mouse, a tablet, and the like), buttons, and a touch panel. The input apparatus 3 is operated by a creator of teacher data.

The input apparatus 3 may be a wireless communication apparatus. The input apparatus 3 may input, for example, the sample x such as image data and voice data generated by a sensor to the interface 4 according to wireless communication.

The interface 4 is, for example, realized by using hardware such as a large scale integration (LSI) and an application specific integrated circuit (ASIC). The interface 4 records the sample x input from the input apparatus 3 in the storage apparatus 6. The interface 4 may output the sample x to the operation processor 8a. The interface 4 outputs a teacher label y input from the input apparatus 3 to the operation processor 8a.

The display apparatus 5 is an image display apparatus such as a cathode ray tube (CRT) display, a liquid crystal display, or an electro-luminescence (EL) display. The display apparatus 5 displays image data acquired from the interface 4. The image data acquired from the interface 4 is, for example, image data of the sample x, image data of a character string representing a teacher label, and numerical data representing the accuracy of an estimated model of machine learning.

The storage apparatus 6 is a non-volatile recording medium (non-transitory recording medium) such as a flash memory and a hard disk drive. The storage apparatus 6 stores a program. The program is, for example, provided to the label collection apparatus 1a as a cloud service. The program may also be provided to the label collection apparatus 1a as an application to be distributed from a server apparatus.

The storage apparatus 6 stores one or more samples x input to the interface 4 by the input apparatus 3. The storage apparatus 6 stores one or more teacher labels y input to the interface 4 by the input apparatus 3 in association with the samples x. The storage apparatus 6 stores one or more pieces of teacher data d that are data in which the samples x and the teacher labels y are associated with each other.

The memory 7 is a volatile recording medium such as a random access memory (RAM). The memory 7 stores a program expanded from the storage apparatus 6. The memory 7 temporarily stores various types of data generated by the operation processor 8a.

The operation processor 8a is configured using a processor such as a central processing unit (CPU). The operation processor 8a functions as an acquirer 80, a learning processor 81, an accuracy detector 82, and a presentation processor 83 by executing the program expanded from the storage apparatus 6 to the memory 7.

The acquirer 80 acquires a teacher label yᵢ input to the interface 4 by the input apparatus 3. The acquirer 80 generates teacher data dᵢ(=(xᵢ,yᵢ)) by associating the teacher label yᵢ to a sample xᵢ displayed on the display apparatus 5. The acquirer 80 records the generated teacher data dᵢ in the storage apparatus 6.

The acquirer 80 acquires a set D of the teacher data dᵢ (=(a set X of the sample xᵢ, a set Y of the teacher label yᵢ)) from the storage apparatus 6 as a data set of teacher data. Note that the acquirer 80 may further acquire the set D of teacher data dⱼ created by another creator as a data set of teacher data in the past. A subscript j of dⱼ represents an index of a sample of teacher data.

The learning processor 81 executes machine learning of an estimated model M on the basis of the set D of the teacher data dᵢ acquired by the acquirer 80. The learning processor 81 may also execute the machine learning of the estimated model M on the basis of the teacher data in the past.

The accuracy detector 82 detects an accuracy of the estimated model M. The accuracy of the estimated model M is a value which can be expressed by a probability, and is, for example, an accuracy rate, a precision rate, or a recall rate of the estimated model M. The accuracy detector 82 may also detect an error of an output variable of the estimated model M, instead of detecting the accuracy of the estimated model M.

The presentation processor 83 generates an image of a numerical value representing the accuracy of the estimated model M. The presentation processor 83 may also generate an image representing each sample included in teacher data. The presentation processor 83 may generate an image such as a character string representing each teacher label included in the teacher data. The presentation processor 83 outputs the generated image to the display apparatus 5.

Next, an operation example will be described.

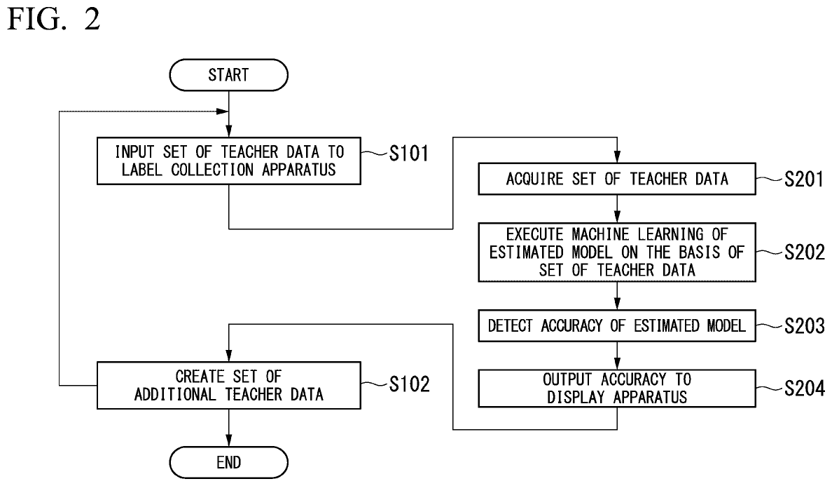

FIG. 2 is a flowchart which shows an example of creation processing of teacher data by a creator and an operation of the label collection apparatus 1a.

The creator inputs the set D of the teacher data dᵢ to the label collection apparatus 1a by giving the teacher label yᵢ to the sample xᵢ (step S101).

The acquirer 80 acquires the set D of the teacher data dᵢ (step S201). The learning processor 81 executes the machine learning of the estimated model M on the basis of the set D of the teacher data dᵢ (step S202). The accuracy detector 82 detects the accuracy of the estimated model M (step S203). The presentation processor 83 causes the display apparatus 5 to display an image of a numerical value representing the accuracy of the estimated model M or the like (step S204).

The presentation processor 83 executes processing of step S204 in real time, for example, while a sensor generates image data and the like. The presentation processor 83 may also execute the processing of step S204 at a predetermined time on a day after the sensor has generated image data and the like.

The creator creates a set of additional teacher data (step S102). Since the creator inputs newly acquired teacher data D⁺ to the learning processor such that the accuracy of the estimated model M exceeds a first accuracy threshold value, processing of step S101 is performed again.

As described above, the label collection apparatus 1a of the first embodiment includes the acquirer 80, the learning processor 81, the accuracy detector 82, and the presentation processor 83. The acquirer 80 acquires a teacher label y of teacher data d used for machine learning. The learning processor 81 executes the machine learning of the estimated model M on the basis of the teacher data dᵢ including the acquired teacher label y and the sample xᵢ. The accuracy detector 82 detects the accuracy of the estimated model M. The presentation processor 83 presents the accuracy of the estimated model M to an operator by causing the display apparatus 5 to display the accuracy of the estimated model M. The acquirer 80 acquires updated teacher data dᵢ+.

As a result, the label collection apparatus 1a can collect the teacher label of teacher data that improves the accuracy of machine learning. Since a quality of updated teacher data is improved, an accuracy of the machine learning with a teacher that recognizes a behavior on the basis of sensor data is improved. The label collection apparatus 1a can execute gamification in which the creator is motivated to improve the quality of teacher data by causing the display apparatus 5 to display the accuracy of the estimated model M.

A apparatus that records a result of the behavior recognition as a work history can record an output variable of the estimated model M in real time. A apparatus that visualizes the result of the behavior recognition can visualize the output variable of the estimated model M in real time. A user can confirm the work history on the basis of the recorded result of the behavior recognition. The user can perform work improvement on the basis of the work history.

### Second Embodiment

A second embodiment is different from the first embodiment in that the label collection apparatus determines whether there is a fraudulent activity (cheating) in which a creator gives a teacher label which is not correct (little relation to a sample) as a behavior label for a sample to the sample. In the second embodiment, differences from the first embodiment will be described.

When teacher data is created, the creator may perform the fraudulent activity in which a creator gives a teacher label which has little relation to a sample to the sample. For example, the creator can give a teacher label “medication” instead of a teacher label “document making” to a sample that is still image data in which a figure of a nurse sitting and making a document is photographed.

The label collection apparatus of the second embodiment determines whether there is a fraudulent activity when a first creator has created first teacher data on the basis of the similarity degree between first teacher data created by the first creator and second teacher data created by one or more second creators who have not performed a fraudulent activity.

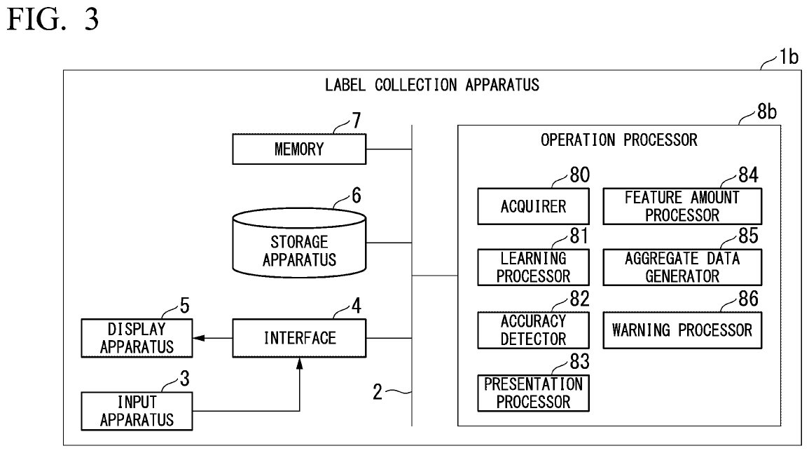

FIG. 3 is a diagram which shows an example of a configuration of the label collection apparatus 1b. The label collection apparatus 1b includes the bus 2, the input apparatus 3, the interface 4, the display apparatus 5, the storage apparatus 6, the memory 7, and an operation processor 8b. The operation processor 8b functions as the acquirer 80, the learning processor 81, the accuracy detector 82, the presentation processor 83, a feature amount processor 84, an aggregate data generator 85, and a warning processor 86 by executing the program expanded from the storage apparatus 6 to the memory 7.

The acquirer 80 acquires a set X of a first sample xᵢ from the storage apparatus 6. The acquirer 80 acquires a set Y of a first teacher label yᵢ given to the first sample xᵢ by a first creator from the storage apparatus 6.

The acquirer 80 acquires a set X′ of a second sample from the storage apparatus 6. The acquirer 80 acquires a set Y′ of a second teacher label yⱼ′ given to a second sample xⱼ′ by one or more second creators who have not performed a fraudulent activity from the storage apparatus 6. The second teacher label yⱼ′ is a teacher label which is correct (hereinafter, referred to as a “legitimate label”) as a behavior label for the sample. Whether the teacher label is a teacher label which has little relation to the sample is determined in advance on the basis of, for example, a predetermined standard.

The feature amount processor 84 calculates a feature amount (hereinafter, referred to as a “first feature amount”) based on a statistical amount of the set X of the first sample xᵢ. The first feature amount is an image feature amount of the first sample xᵢ, for example, when the first sample xᵢ is image data.

The feature amount processor 84 calculates a feature amount (hereinafter, referred to as a “second feature amount”) based on a statistic amount of the set X′ of the second sample xⱼ′. The second feature amount is an image feature amount of the second sample xⱼ′, for example, when the second sample xⱼ′ is image data. [0051]

The aggregate data generator 85 generates the set D (={(x₁, y₁), . . . }) of the first teacher data dᵢ by combining the set X of the first sample xᵢ and the set Y of the first teacher label yᵢ. The aggregate data generator 85 generates the set D′ (={(x₁′,y₁′), . . . }) of the second teacher data dᵢ by combining the set X′ of the second sample xⱼ and the set Y′ of the second teacher label yⱼ.

The warning processor 86 calculates a similarity degree Gᵢ (i=1, 2, . . . ) between the set D of the first teacher data and the set D′ of the second teacher data on the basis of, for example, a first feature amount V and a second feature amount V′ according to a threshold value method or an abnormality detection method. Note that these methods are examples.

(Threshold Value Method)

The warning processor 86 calculates, for example, an average value h of each distance from the first teacher data dᵢ to the second teacher data dⱼ (j=1,2, . . . ) as the similarity degree Gᵢ. The distance is a distance between a vector that is a combination of the first feature amount V and the first teacher data and a vector that is a combination of the second feature amount V′ and the second teacher data. When the average value h of each distance is equal to or greater than a threshold value, the similarity Gᵢ is 1. When the average value h of each distance is less than the threshold value, the similarity degree Gᵢ is 0.

(Abnormality Detection Method)

The warning processor 86 may also calculate a reciprocal (normality degree) of an abnormality degree of the first teacher data dᵢ for the second teacher data dⱼ (j=1, 2, . . . ) as the similarity degree Gᵢ. The abnormality degree may be an absolute value of a distance between the first teacher data dᵢ and the second teacher data dⱼ, that is, a difference between the first feature amount V obtained from the first teacher data and the second feature amount V′ obtained from the second teacher data. Alternatively, the abnormality degree may also be a Euclidean distance between the first feature amount V obtained from the first data and the second feature amount V′ obtained from the second teacher data. An upper limit may also be set for the abnormality degree.

The warning processor 86 calculates an average value H of the similarity degree Gᵢ (i=1, 2, . . . ). The warning processor 86 determines whether the average value H of the similarity Gᵢ exceeds a similarity threshold value. The similarity threshold value is, for example, 0.5 when the similarity degree Gᵢ is 1 or 0.

The presentation processor 83 outputs the average value H of the similarity degree Gᵢ to the display apparatus 5. The presentation processor 83 outputs a warning indicating that the fraudulent activity is highly likely to have been performed for a creation of the first teacher data dᵢ to the display apparatus 5 when it is determined that the average value H of the similarity degree Gᵢ is equal to or less than the similarity threshold value.

Next, an example of an operation of the label collection apparatus 1b will be described.

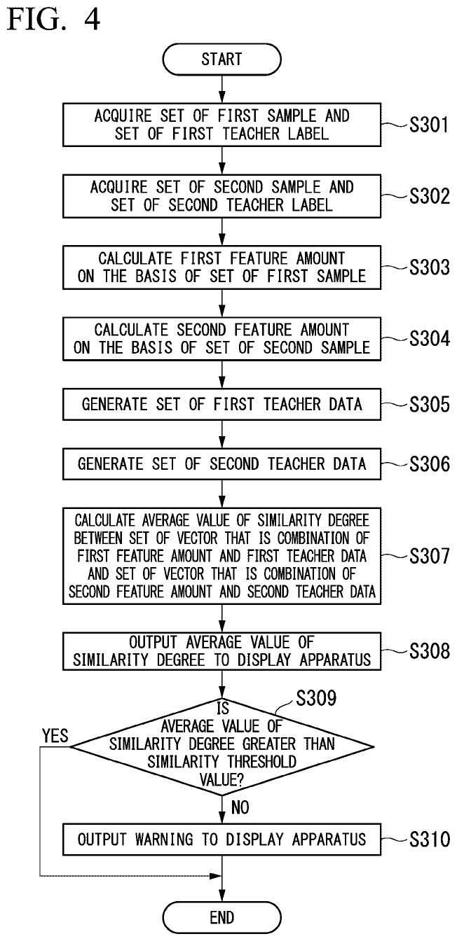

FIG. 4 is a flowchart which shows an example of an operation of the label collection apparatus 1b. The acquirer 80 acquires the set X of the first sample xᵢ and the set Y of the first teacher label yᵢ (step S301). The acquirer 80 acquires the set X′ of the second sample and the set Y′ of the second teacher label yⱼ′ (step S302).

The feature amount processor 84 calculates the first feature amount V on the basis of the set X of the first sample xᵢ (step S303). The feature amount processor 84 calculates the second feature amount V′ on the basis of the set X′ of the second sample xⱼ′ (step S304).

The aggregate data generator 85 generates the set D of the first teacher data dᵢ (step S305). The aggregate data generator 85 generates the set D′ of the second teacher data dⱼ (step S306).

The warning processor 86 calculates the average value H of the similarity degree Gᵢ between a set of the vector that is the combination of the first feature amount and the first teacher data and a set of the vector that is the combination of the second feature amount and the second teacher data (step S307). The presentation processor 83 outputs the average value H of the similarity degree Gᵢ to the display apparatus 5 (step S308).

The warning processor 86 determines whether the average value H of the similarity degree Gᵢ exceeds the similarity threshold value (step 309). When it is determined that the average value H of the similarity degree Gᵢ exceeds the similarity threshold value (YES in step S309), the label collection apparatus 1b ends processing of the flowchart shown in FIG. 4. When it is determined that the average value H of the similarity degree G is equal to or less than the similarity threshold value (NO in step S309), the presentation processor 83 outputs a warning to the display apparatus 5 (step S310).

As described above, the label collection apparatus 1b of the second embodiment includes the acquirer 80, the learning processor 81, the accuracy detector 82, the presentation processor 83, and the warning processor 86. The acquirer 80 acquires a first teacher label yᵢ of first teacher data dᵢ used for machine learning. The learning processor 81 executes the machine learning of the estimated model M on the basis of the first teacher data dᵢ including the acquired first teacher label yᵢ and the sample xᵢ. The accuracy detector 82 detects the accuracy of the estimated model M. The presentation processor 83 presents the accuracy of the estimated model M to an operator by causing the display apparatus 5 to display the accuracy of the estimated model M. The warning processor 86 outputs a warning when a similarity degree between the second teacher data dⱼ including a second teacher label (legitimate label) that does not have little relation to a sample and the first teacher data dᵢ is equal to or less than a predetermined similarity threshold value. Furthermore, the acquirer 80 acquires updated first teacher data dᵢ.

As a result, the label collection apparatus 1b of the second embodiment makes it possible to present the similarity degree between a set of teacher data created by a creator and a set of teacher data created by another creator to a user. In addition, the label collection apparatus 1b can output a warning when the similarity degree between the second teacher data dⱼ and the first teacher data dᵢ is equal to or less than the predetermined similarity threshold value.

### Third Embodiment

A third embodiment is different from the second embodiment in that the label collection apparatus determines whether there is a fraudulent activity using a determination model in which machine learning is executed. In the third embodiment, differences from the second embodiment will be described.

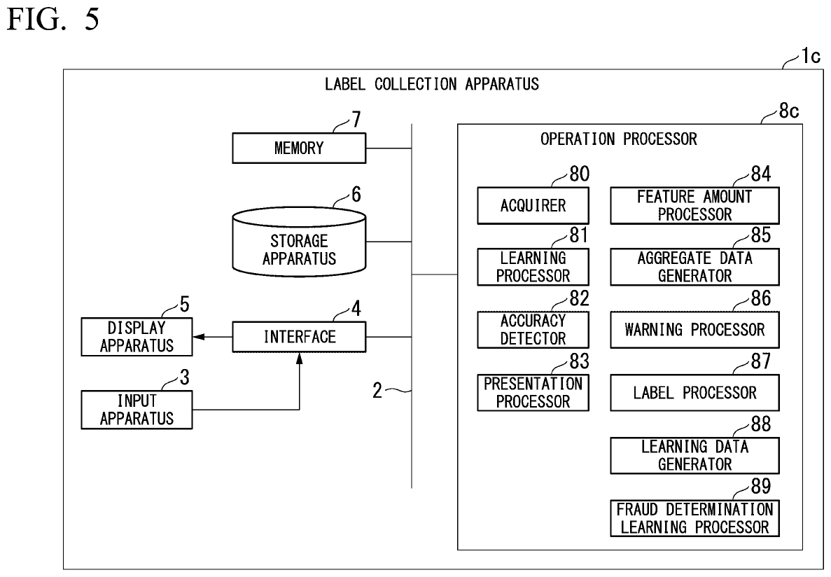

FIG. 5 is a diagram which shows an example of a configuration of a label collection apparatus 1c. The label collection apparatus 1c includes the bus 2, the input apparatus 3, the interface 4, the display apparatus 5, the storage apparatus 6, the memory 7, and an operation processor 8c. The operation processor 8b functions as the acquirer 80, the learning processor 81, the accuracy detector 82, the presentation processor 83, the feature amount processor 84, the aggregate data generator 85, the warning processor 86, a label processor 87, a learning data generator 88, and a fraud determination learning processor 89 by executing the program expanded from the storage apparatus 6 to the memory 7.

The acquirer 80 acquires the set X of the first sample xᵢ and the set Y of the first sample yᵢ given to the first sample xᵢ by the first creator. The acquirer 80 acquires the set X′ of the second sample and the set Y′ of the second teacher label yⱼ′ given to the second sample xⱼ′ by one or more second creators who have not performed a fraudulent activity. The acquirer 80 acquires a set X″ of a third sample and a set Y″ of a third teacher label yₖ″ given to a third sample xₖ″ by one or more third creators who have intentionally performed a fraudulent activity. A subscript k of xk″ represents an index of the third sample.

The aggregate data generator 85 generates the set D (={(x₁, y₁), . . . }) of the first teacher data dᵢ by combining the set X of the first sample xᵢ and the set Y of the first teacher label yᵢ. The aggregate data generator 85 generates the set D′ (={(x₁′,y₁′), . . . }) of the second teacher data dⱼ by combining the set X′ of the second sample xⱼ and the set Y′ of the second teacher label yⱼ. The aggregate data generator 85 generates a set D″ (={(x₁″, y₁″), . . . }) of a third teacher data dₖ by combining a set X″ of a third sample xₖ and a set Y″ of a third teacher label yₖ.

The label processor 87 includes a legitimate label in the set D′ of the second teacher data. For example, the label processor 87 updates a configuration (second sample xⱼ′, second teacher label yⱼ′) of second teacher data dⱼ′ with a configuration such as (second sample xⱼ′, second teacher label yⱼ′, legitimate label rⱼ′).

The label processor 87 includes a teacher label which is not correct as a behavior label for a sample (hereinafter, referred to as a “fraud label”) in the set D″ of the third teacher data. For example, the label processor 87 updates a configuration (third sample xₖ″, third teacher label yₖ″) of third teacher data dₖ″ with a configuration such as (third sample xₖ″, third teacher label yₖ″, fraud label rₖ″).

The learning data generator 88 generates learning data that is data used for machine learning of a determination model F on the basis of the set D′ of the second teacher data and the set D″ of the third teacher data. The determination model F is a model of machine learning and is a model used for determining whether there is a fraudulent activity.

In a learning phase, the fraud determination learning processor 89 executes the machine learning of the determination model F by setting the generated learning data as an input variable and an output variable of the determination model F. The fraud determination learning processor 89 records the determination model F in which machine learning has been executed in the storage apparatus 6.

In a determination phase after the learning phase, the fraud determination learning processor 89 sets the first teacher data dᵢ as the input variable of the determination model F and detects an output Pᵢ (=F(dᵢ)) of the determination model F in the set D of the first teacher data. When the legitimate label and the fraud label are expressed by two values, the output Pᵢ indicating the legitimate label is 0 and the output variable Pᵢ indicating the fraud label is 1. Note that the output Pᵢ may be expressed by a probability from 0 to 1.

In the determination phase, the warning processor 86 calculates an average value of the outputs Pᵢ (i=1, 2, . . . ) as an average value H′ of the accuracy of the determination model F. The warning processor 86 determines whether the average value H′ of the accuracy of the determination model F exceeds a second accuracy threshold value. The second accuracy threshold value is, for example, 0.5 when the output Pᵢ is 1 or 0. The accuracy of the determination model F is a value that can be expressed by a probability, and is, for example, an accuracy rate, a precision rate, or a recall rate of the determination model F.

The presentation processor 83 outputs the average value H′ of the accuracy of the determination model F to the display apparatus 5. The presentation processor 83 outputs a warning to the display apparatus 5 when it is determined that the average value H′ of the accuracy of the determination model F is equal to or less than the second accuracy threshold value.

Next, an example of an operation of the label collection apparatus 1c will be described.

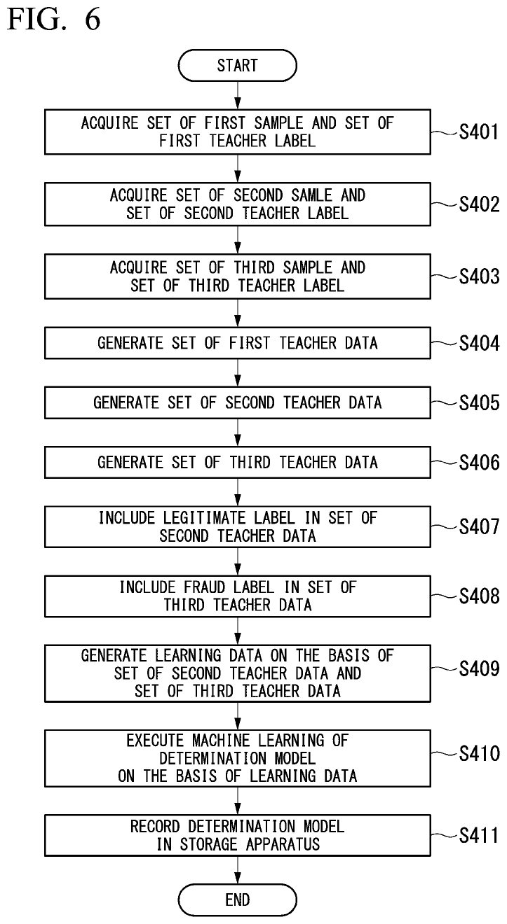

FIG. 6 is a flowchart which shows a learning example (learning phase) of the determination model F. The acquirer 80 acquires the set X of the first sample xᵢ and the set Y of the first teacher label yᵢ (step S401). The acquirer 80 acquires the set X′ of the second sample and the set Y′ of the second teacher label yⱼ′ (step S402). The acquirer 80 acquires the set X″ of the third sample and the set Y″ of the third teacher label yₖ″ (step S403).

The aggregate data generator 85 generates the set D of the first teacher data dᵢ (step S404). The aggregate data generator 85 generates the set D′ of the second teacher data dⱼ (step S405). The aggregate data generator 85 generates the set D″ of the third teacher data dₖ (step S406).

The label processor 87 includes a legitimate label in the set D′ of the second teacher data (step S407). The label processor 87 includes a fraud label in the set D″ of the third teacher data (step S408).

The learning data generator 88 generates learning data on the basis of the set D′ of the second teacher data and the set D″ of the third teacher data (step S409). The fraud determination learning processor 89 executes the machine learning of the determination model F (step S410). The fraud determination learning processor 89 records the determination model F in which machine learning is executed in the storage apparatus 6 (step S411).

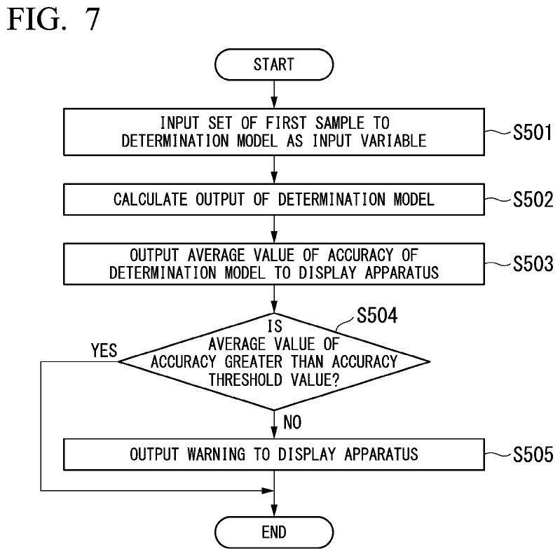

FIG. 7 is a flowchart which shows a determination example (determination phase) of the accuracy of the determination model F. The fraud determination learning processor 89 inputs the set X of the first sample in the determination model F as an input variable (step S501). The warning processor 86 calculates an average value of the output Pᵢ (an output of the determination model F) as the average value H′ of the accuracy of the determination model F (step S502). The presentation processor 83 outputs the average value H′ of the accuracy of the determination model F to the display apparatus 5 (step S503).

The warning processor 86 determines whether the average value H′ of the accuracy of the determination model F exceeds the second accuracy threshold value (step S504). When it is determined that the average value H′ of the accuracy of the determination model F exceeds the second accuracy threshold value (YES in step S504), the label collection apparatus 1c ends processing of the flowchart shown in FIG. 7. When it is determined that the average value H′ of the accuracy of the determination model F is equal to or less than the second accuracy threshold value (NO in step S504), the presentation processor 83 outputs a warning to the display apparatus 5 (step S505).

As described above, the label collection apparatus 1c of the third embodiment includes the learning processor 81 and the warning processor 86. The learning processor 81 executes the machine learning of the determination model F on the basis of the second teacher data dⱼ and the third teacher data dₖ including the third teacher label (fraud label) that has little relation to a sample. The warning processor 86 outputs a warning when the accuracy of the determination model F for the first teacher data dᵢ is equal to or less than a second predetermined accuracy threshold value.

As a result, the label collection apparatus 1c of the third embodiment can determine whether there is a fraudulent activity when a creator creates teacher data using the determination model F for each creator. When the first teacher data dᵢ is composed of one first sample xᵢ and one teacher label yᵢ, the label collection apparatus 1c can determine whether the one first sample xᵢ is a sample created according to the fraudulent activity.

As described above, the embodiments of the present invention have been described in detail with reference to the drawings, but the specific configuration is not limited to these embodiments, and also includes a design and the like within a range not departing from the gist of the present invention.

### INDUSTRIAL APPLICABILITY

The present invention is applicable to an information processing apparatus that collects a teacher label of teacher data.

### REFERENCE SIGNS LIST

1a, 1b, 1c Label collection apparatus

2 Bus

3 Input apparatus

4 Interface

5 Display apparatus

6 Storage apparatus

7 Memory

8a, 8b, 8c Operation processor

80 Acquirer

81 Learning processor

82 Accuracy detector

83 Presentation processor

84 Feature amount processor

85 Aggregate data generator

86 Warning processor

87 Label processor

88 Learning data generator

89 Fraud determination learning processor

1. A label collection apparatus comprising:
an acquirer configured to acquire a teacher label of teacher data used for machine learning;
a learning processor configured to execute machine learning of a model on the basis of the teacher data including the acquired teacher label;
an accuracy detector configured to detect an accuracy of the model; and
a presentation processor configured to present the accuracy,
wherein the acquirer is configured to acquire updated teacher data.

2. A label collection apparatus comprising:
an acquirer configured to acquire a first teacher label of first teacher data used for machine learning;
a learning processor configured to execute machine learning of a first model on the basis of the first teacher data including an acquired first teacher label and a sample;
an accuracy detector configured to detect an accuracy of the first model;
a presentation processor configured to present the accuracy; and
a warning processor configured to output a warning when a similarity degree between the first teacher data and second teacher data including a second teacher label which is a correct as a behavior label for the sample is equal to or less than a predetermined similarity threshold value,
wherein the acquirer is configured to acquire updated first teacher data.

3. The label collection apparatus according to claim 2,
wherein the learning processor is configured to execute machine learning of a second model on the basis of third teacher data including a third teacher label which is not correct as a behavior label for the sample and the second teacher data including the second teacher label, and
the warning processor is configured to output a warning when an accuracy of the second model for the first teacher data is equal to or less than a predetermined accuracy threshold value.

4. The label collection apparatus according to claim 2,
wherein the sample is sensor data, and
the first teacher label is a label representing a behavior of a person.

5. A label collection method comprising:
a step of acquiring a first teacher label of first teacher data used for machine learning;
a step of executing machine learning of a first model on the basis of the first teacher data including the acquired first teacher label and a sample;
a step of detecting an accuracy of the first model;
a step of presenting the accuracy;
a step of outputting a warning when a similarity degree between the first teacher data and second teacher data including a second teacher label which does not have little relation to the sample is equal to or less than a predetermined similarity threshold value; and
a step of acquiring updated first teacher data.

6. A non-transitory computer readabled medium for storing a label collection program, comprising:
the computer readable medium for causing a computer to execute:
a procedure for acquiring a first teacher label of first teacher data used for machine learning;
a procedure for executing machine learning of a first model on the basis of the first teacher data including the acquired first teacher label and a sample;
a procedure for detecting an accuracy of the first model;
a procedure for presenting the accuracy;
a procedure for outputting a warning when a similarity degree between the first teacher data and second teacher data including a second teacher label which does not have little relation to the sample is equal to or less than a predetermined similarity threshold value; and
a procedure for acquiring updated first teacher data.
